(19) United States
(12) Patent Application Publication
(10) Pub. No.: US 2008/0143178 A1
(43) Pub. Date: Jun. 19, 2008

(54) Braking Device for a Rail Vehicle

(76) Inventor: Manfred Wiesand, Burgthann (DE)

Correspondence Address: HARNESS, DICKEY & PIERCE, P.L.C., P.O.BOX 8910, RESTON, VA, 20195, US

(21) Appl. No.: 11/884,489

(22) PCT Filed: Feb. 14, 2006
(86) PCT No.: PCT/EP2006/050929

§ 371 Date: Aug. 16, 2007

(30) Foreign Application Priority Data
Feb. 17, 2005 (DE) 10 2005 007 336.0

(51) Int. Cl. B60T 8/88; B60T 17/22

(52) U.S. Cl. 303/122.05

(57) ABSTRACT

A braking device is disclosed for a rail vehicle, in which a braking control unit is linked to braking units via a data bus system. According to an embodiment of the invention, the data bus system is designed to transmit telegrams and a fail-safe unit is assigned to the data bus system to identify transmission errors. The fail-safe unit is linked on the output side to braking units of the service brake and the emergency brake, in order to trigger the braking units in the event of a transmission error.

### PRIORITY STATEMENT

This application is the national phase under 35 U.S.C. § 371 of PCT International Application No. PCT/EP2006/050929 which has an International filing date of Feb. 14, 2006, which designated the United States of America and which claims priority on German Patent Application number 10 2005 007 336.0 filed Feb. 17, 2005, the entire contents of which are hereby incorporated herein by reference.

### FIELD

At least one embodiment of the invention generally relates to a braking device for a rail vehicle; for example to one wherein a brake control unit is connected to brake units via a data bus system.

### BACKGROUND

A braking device is provided in every rail vehicle. The braking device is triggered either by the driver of the vehicle who activates a switch or a valve, or by a safety device. For use under particularly hazardous conditions, for example when there is a fire, a quick-acting braking device is provided in a rail vehicle. Known quick-acting braking devices are always configured in such a way that the rail vehicle is braked immediately to a standstill and that it is difficult to release the brake during the braking process or else in the stationary state. The intention is to make the rail vehicle particularly safe.

A quick-acting braking device has previously been implemented by, for example in the case of a compressed air brake, completely venting the main air line. This venting activates the brake units and achieves the maximum braking force.

According to another known example of a quick acting braking device, an electrical loop into which all the brake units are connected is installed through a train. If the voltage at the brake units drops due to an interruption in the electrical loop, these brake units close with maximum braking force.

DE 101 28 897 C1 discloses a braking device in which a data bus system connects a brake control unit and braking units. With such a braking device it was previously not possible to bring about the maximum braking force at short notice when there was a defect in the brake system.

### SUMMARY

At least one embodiment of the invention specifies a braking device which is quick acting through use of a data bus system and nevertheless makes it possible for the maximum braking force to be available quickly in the event of a defect in the brake system.

In at least one embodiment, the data bus system is used to transmit telegrams and that the data bus system is assigned a fail-safe device in order to detect transmission errors, which fail-safe device is connected at the output end to brake units of the service brake and of the emergency brake, in order to trigger brake units if a transmission error occurs.

This provides an advantage that the brake units are actuated directly by way of signals which are generally digital signals. These are less susceptible to faults than variables such as, for example, the air pressure in a line or the electrical voltage, which were previously used to actuate the brake units. Nevertheless it is ensured that the maximum braking force is achieved immediately in the event of a defect in the brake system.

### DETAILED DESCRIPTION OF THE EXAMPLE EMBODIMENTS

For example, a device for detecting the time period between the outputting of a telegram and its arrival via the data bus system is provided, which device is connected to a threshold value transmitter and a control device, in order to trigger the brake units if the time period is longer than the threshold value of the threshold value transmitter.

An advantage is achieved that a defect in the brake system can easily be perceived solely through the detection of an excessively long time period.

For example, the brake units have modules for checking the telegrams which have arrived. It is therefore possible to transmit messages with the telegrams.

For example, the telegrams each contain an indication of the outputting brake control unit. Therefore, in the case of a motive power unit with two driver's cabs it is possible to detect which driver's cab is activated at a particular time. Telegrams which then appear to originate from the driver's cab which is not activated can be disregarded.

For example, a brake control unit, which is assigned a switch for the purpose of activation, is arranged in the driver's cab. This makes it possible, in the particularly simple way, for the driver of the vehicle to be able to switch off the brake control unit, and thus the entire quick-acting brake device if necessary. This is particularly appropriate if the train would otherwise come to a standstill in a tunnel, which would be hazardous, for example, in the event of a fire in the train.

For example, the data bus system is connected via a first gateway to a train bus which is connected via a second gateway to a data bus system of another, coupled rail vehicle. The use of this train bus makes it possible to connect to one another a plurality of complete motive power units which, for example, each have two driver's cabs, in which case all the brake units are operated from one driver's cab.

For example, the telegrams which arrive via the train bus contain an indication of the first gateway which is assigned to the outputting brake control unit. This indirectly ensures that in the coupled train only those telegrams which come from the driver's cab of the other train are considered. Faults are thus largely avoided.

In order to improve the reliability, the telegrams can, for example, be transmitted redundantly.

The at least one brake control unit is, for example, part of a train protection device. This train protection device permits driverless operation and ensures that the brake control unit is incorporated for automated braking with all the previously known advantages.

For example, the brake units have their own voltage supplies. As a result, a power supply line which would have to be routed through the entire rail vehicle is advantageously not required. In fact, it is possible for no power supply to be provided via the data bus system.

For example, the brake units have sensors for the brake pressure, which sensors are connected to the at least one brake control unit. This provides the advantage that the driver of the vehicle can be informed of a reduced brake pressure.

For example, the at least one brake control unit has an input interface for signals. It is therefore advantageously possible for this brake control unit also to be switched automatically without a driver of a vehicle intervening.

For example, an emergency travel mode switch for bypassing braking commands is connected to the input interface. Activation of the emergency travel mode switch, for example by the driver of the vehicle, causes all the previous commands to be cancelled so that a rail vehicle can still leave a hazardous point before it stops. Such a hazardous point may be a tunnel.

For example, two emergency travel mode switches on which an AND logic operation has been carried out are provided.

For example, an OR logic operation is carried out on signals for braking and an AND logic operation is carried out on signals for the emergency travel mode, at the input interface. This provides the advantage that emergency braking can be triggered very quickly by a single signal while interruption in the emergency braking is possible only if a plurality of signals on which an AND logic operation has been carried out require the brake to be released. Consequently, undesired interruption of the emergency braking is ruled out.

For the driverless operating mode, for example a sensor system for monitoring the track region is connected to the input interface. Such a sensor system, which may be, for example, an image-recording camera, reliably ensures undisrupted driverless operation since obstacles in the track region can be detected in such good time that the rail vehicle can stop before the obstacle.

For example, the at least one brake control unit is part of a control center which is connected to its input interface and to the data bus system in a wireless fashion. This makes central evaluation of the braking processes possible even outside the rail vehicle.

The braking device according to an embodiment of the invention provides, in particular, the advantage that the brake units can be activated quickly and reliably, and rapid braking is possible even when there is a defect in the brake system. Furthermore, when necessary it is also possible to interrupt the braking process at short notice so that the rail vehicle does not stop in a tunnel.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A braking device for a rail vehicle, comprising:
at least one brake control unit, connected to brake units via a data bus system which is usable to transmit telegrams and which is assigned a fail-safe device, the fail-safe device being usable to detect transmission errors and being connected, for this purpose, at an output end to brake units of the service brake and of the emergency brake, in order to trigger brake units if a transmission error occurs, the at least one brake control unit including an input interface for signals, an OR logic operation being carried out on signals for braking and an AND logic operation being carried out on signals for emergency travel mode, at the input interface.

2. The braking device as claimed in claim 1, further comprising a device for detecting the time period between the outputting of a telegram and its arrival via the data bus system, the device for detecting being connected to a threshold value transmitter and a control device, in order to trigger the brake units if the time period is longer than the threshold value of the threshold value transmitter.

3. The braking device as claimed in claim 1, wherein the brake units include modules for checking the telegrams which have arrived.

4. The braking device as claimed in claim 1, wherein the telegrams contain an indication of the outputting brake control unit.

5. The braking device as claimed in claim 1, wherein a brake control unit, which is assigned a switch for the purpose of activation, is arranged in the driver's cab.

6. The braking device as claimed in claim 1, wherein the data bus system is connected via a first gateway to a train bus which is connected via a second gateway to a data bus system of another, coupled rail vehicle.

7. The braking device as claimed in claim 6, wherein the telegrams which arrive via the train bus contain an indication of the first gateway which is assigned to the outputting brake control unit.

8. The braking device as claimed in claim 7, wherein the telegrams can be transmitted redundantly.

9. The braking device as claimed in claim 1, wherein the at least one brake control unit is part of a train protection device.

10. The braking device as claimed in claim 1, wherein the brake units have their own voltage supplies.

11. The braking device as claimed in claim 1, wherein the brake units have sensors for the brake pressure, which sensors are connected to the at least one brake control unit.

12. The braking device as claimed in claim 1, wherein an emergency travel mode for bypassing braking commands switch is connected to the input interface.

13. The braking device as claimed in claim 12, further comprising two emergency travel mode switches on which an AND logic operation has been carried out.

14. The braking device as claimed in claim 1, wherein a sensor system for monitoring the track region is connected for driverless operation to the input interface.

15. The braking device as claimed in claim 1, wherein the at least one brake control unit is part of a control center which is connected to an input interface and to the data bus system in a wireless fashion.

16. The braking device as claimed in claim 12, wherein a sensor system for monitoring the track region is connected for driverless operation to the input interface.

17. The braking device as claimed in claim 12, wherein the at least one brake control unit is part of a control center which is connected to an input interface and to the data bus system in a wireless fashion.

18. The braking device as claimed in claim 2, wherein the brake units include modules for checking the telegrams which have arrived.

19. A braking device for a rail vehicle, comprising:
at least one brake control unit;
a data bus system, connecting at least one brake unit to the at least one brake control unit, to transmit telegrams; and
a fail-safe device, assigned to the data bus system, to detect a transmission error, the fail-safe device being connected, at an output end to at least one brake unit of at least one of a service brake and an emergency brake, to trigger at least one brake unit upon detecting a transmission error, the at least one brake control unit including an input interface for signals, wherein an OR logic operation is carried out on signals for braking and an AND logic operation is carried out on signals for emergency travel mode, at the input interface.

20. The braking device as claimed in claim 19, further comprising a device to detect a time period between the outputting of a telegram and an arrival via the data bus system, the device to detect being connected to a threshold value transmitter and a control device, in order to trigger the brake units if the time period is longer than the threshold value of the threshold value transmitter.
